(19) United States
(12) Patent Application Publication
(10) Pub. No.: US 2025/0382236 A1
(43) Pub. Date: Dec. 18, 2025

(54) OXYGENATING AND ROOTING WATER-SOLUBLE FERTILIZER COMPOUNDED WITH BIOSTIMULANT AND PREPARATION METHOD THEREFOR

(71) Applicant: Shandong Bainong Sida Biotechnology Co., Ltd., Qingzhou (CN)

(72) Inventors: Ke Liu, Qingzhou (CN); Jian Chen, Qingzhou (CN)

(21) Appl. No.: 18/769,300

(22) Filed: Jul. 10, 2024

(30) Foreign Application Priority Data
Jun. 13, 2024 (CN) 202410756418.9

(51) Int. Cl. C05B 7/00; C05C 5/00; C05C 5/02; C05C 9/00; C05F 11/02; C05F 11/10; C05G 3/60

(52) U.S. Cl. CPC C05B 7/00; C05C 5/005; C05C 5/02; C05C 9/005; C05F 11/02; C05F 11/10; C05G 3/60

(57) ABSTRACT

The present disclosure relates to an oxygenating and rooting water-soluble fertilizer compounded with biostimulant, prepared by the following raw materials in parts by weight: 10-30 parts of urea powder, 20-35 parts of industrial grade monoammonium phosphate powder, 30-40 parts of potassium nitrate powder, 1-5 parts of oxygenating agent powder, 1-10 parts of type I stabilizer powder, 1-5 parts of type II stabilizer powder, 2.5-10 parts of biostimulant powder, 1.5-4 parts of medium trace element powder, and 0.5-1 part of anti-hardening auxiliary agent powder. The synergistic effect between oxygenating function of the water-soluble fertilizer and compounded biostimulant on crop root systems effectively increases dissolved oxygen content of crop rhizosphere and promotes the aerobic respiration of the crop root systems.

### CROSS-REFERENCE TO RELATED APPLICATIONS

This application claims priority of Chinese Patent Application No. 202410756418.9, filed on Jun. 13, 2024, the entire contents of which are incorporated herein by reference.

### TECHNICAL FIELD

The present disclosure relates to the technical field of agricultural fertilizers, and in particular to an oxygenating and rooting water-soluble fertilizer compounded with biostimulant and a preparation method therefor.

### BACKGROUND

With the intensified farmland planting, the soil environment of farmland is experiencing increased deterioration, which is an important problem the agricultural development facing. The prominent problems such as soil hardening, stick and heavy soil, and poor air permeability seriously impede the aerobic respiration and normal growth of crop root systems, thus impeding the increase in production and income of crops. In addition, hypoxia of root system leads to changes in the rhizosphere microflora, and enhanced anaerobic respiration, which prevents the autotoxic substances produced by the crop from being quickly decomposed, is an important reason for the increasing incidence of soil-borne diseases. At this stage, poor soil permeability caused by problems such as soil hardening, stick and heavy soil, and flooding is generally repaired by plowing farmland, applying organic fertilizers, returning crop straw to farmland and applying chemical macro-molecular improvement agent, but all these methods have obvious shortcomings. For example, deep plowing of farmland over a long stage of time may destroy soil granular structure, and although the poor soil permeability can be improved in the short term, the quality of arable land will be reduced in the long term. Increasing the application of organic fertilizers can effectively improve the organic matter content of farmland soil, improve the soil granular structure, increase the soil permeability, but the improvement by organic fertilizers lasts for a long period of time, with high costs inputted. Returning crop straw to farmland is a popular soil improvement measure in recent years; the decomposition of crop straw can supplement crops with nutrients such as nitrogen, phosphorus and potassium, and also increase the organic matter content and soil permeability of soil; however, the soil carbon emissions are increased to a certain extent, and crop straw, especially commercial crops, contains a large number of insect eggs, which leads to the occurrence of crop diseases. The use of chemical improvement agent or macro-molecular improvement agent involves large technical inputs, high improvement costs, and pollution of agricultural soils.

Research on fertilizer oxygenating technology has been carried out in many countries for a long time and has been widely used in many fields such as agriculture and environmental protection. At the end of the 20th century and the beginning of the 21st century, oxygenating agents had been applied in aquaculture and other fields, but, there were fewer cases of agriculture planting in which oxygenating technology had been applied. How to apply oxygenating technology to the field of new fertilizers to improve the poor soil permeability, break the anaerobic environment in the crop rhizosphere without increasing agricultural costs and labor, and increase crop yields, is of great significance to the development of new fertilizers and even the entire agriculture.

### SUMMARY

The technical problem to be solved by the present disclosure is to provide an oxygenating and rooting water-soluble fertilizer compounded with biostimulant and a preparation method therefor. The oxygenating and rooting water-soluble fertilizer compounded with biostimulant has oxygenating and rooting effect and is compounded with biostimulant, having the function of rhizosphere oxygenating, improving the dissolved oxygen content of crop rhizosphere, breaking the anaerobic environment of the crop rhizosphere, and featuring green and environmental protection and no increase in the agricultural and labor costs basically.

To solve the above technical problem, the present disclosure employs the following technical solutions. An oxygenating and rooting water-soluble fertilizer compounded with biostimulant is provided, which is prepared by the following raw materials in parts by weight: 10-30 parts of urea powder, 20-35 parts of industrial grade monoammonium phosphate powder, 30-40 parts of potassium nitrate powder, 1-5 parts of oxygenating agent powder, 1-10 parts of type I stabilizer powder, 1-5 parts of type II stabilizer powder, 2.5-10 parts of biostimulant powder, 1.5-4 parts of medium trace element powder, and 0.5-1 part of anti-hardening auxiliary agent powder.

In a preferred technical solution, the oxygenating agent powder is urea peroxide with a mass percentage of oxygen content of 14%-16%.

In a preferred technical solution, the type I stabilizer powder is anhydrous magnesium sulfate powder, and the type II stabilizer powder is potassium pyrophosphate powder, the potassium pyrophosphate powder having a pH value of 8-10 after being diluted by 1:250 times.

In a preferred technical solution, the biostimulant powder is formed by the following raw materials in parts by weight: 1-5 parts of seaweed active substance powder, 0.5-2 parts of humic acid powder, 0.5-2 parts of γ-aminobutyric acid powder, and 0.5-1 part of vitamin powder.

In a preferred technical solution, the seaweed active substance powder is seaweed polysaccharide powder, with a mass percentage of alginic acid content of 20%-30%, a mass percentage of seaweed polysaccharide content of 15%-20%, and a mass percentage of organic matter content of 25%-30%, the seaweed active substance powder having a pH value of 5-7 after being diluted by 1:250 times.

In a preferred technical solution, the humic acid powder is mineral potassium fulvic acid powder, with a mass percentage of fulvic acid content of 45%-50%, a mass percentage of humic acid content of 50%-55%, and a mass percentage of potassium oxide content of 8%-12%.

In a preferred technical solution, the vitamin powder is vitamin C, a mass percentage of vitamin C content being 90%-99%.

In a preferred technical solution, the medium trace element powder is at least one of ethylene diamine tetraacetic acid (EDTA)-Fe powder, boric acid powder and EDTA-Zn powder.

A preparation method for an oxygenating and rooting water-soluble fertilizer compounded with biostimulant includes the following steps:
step 1, fully and uniformly mixing oxygenating agent powder, type I stabilizer powder and type II stabilizer powder according to a predetermined weight ratio, leaving a mixture for 1 h or more to fully stabilize for later use, and obtaining an intermediate product A;
step 2, performing stirring while sequentially adding urea powder, industrial grade monoammonium phosphate powder and potassium nitrate powder to a water-soluble fertilizer mixing machine according to a predetermined weight ratio, a rotational speed of the mixing machine being controlled at 200 rpm/min-260 rpm/min, and obtaining an intermediate product B;
step 3, performing stirring while adding biostimulant powder to the intermediate product B obtained by the mixing machine according to a predetermined weight ratio, a rotational speed of the mixing machine being controlled at 200 rpm/min-260 rpm/min, and obtaining an intermediate product C;
step 4, performing stirring while sequentially adding medium trace element powder and anti-hardening auxiliary agent powder to the intermediate product C obtained by the mixing machine according to a predetermined weight ratio, a rotational speed of the mixing machine being controlled at 200 rpm/min-260 rpm/min, and obtaining an intermediate product D; and
step 5, adding the intermediate product A to the intermediate product D obtained by the mixing machine according to a predetermined weight ratio, and continuing to fully and uniformly mixing for 8 min-9 min to obtain a final product, a water-soluble fertilizer.

In a preferred technical solution, moisture content of all raw materials is controlled at 3% or less, a temperature of a production workshop is controlled at lower than 27° C., and air humidity is controlled at 30%-50%.

The present disclosure has the following advantageous effects by adopting the above technical solutions. The oxygenating function of the water-soluble fertilizer and the compounded biostimulant has synergistic effect on crop root systems. The oxygenating function of the water-soluble fertilizer effectively increases the dissolved oxygen content of crop rhizosphere and promotes the aerobic respiration of the crop root systems, and synergistically affects the crop root systems together with the compounded biostimulant, greatly improving the growth of the crop root systems, promoting the high-quality growth and yield of crops, and minimizing the problems of poor crop growth, yield reduction and quality decline of agricultural products caused by the poor permeability of the crop root systems due to soil hardening, and sticky and heavy soil. At the same time, the preparation method of the present disclosure is simple, with easily accessible raw materials of oxygenating agent and biostimulant, and is conducive to industrialized production.

### DETAILED DESCRIPTION

The present disclosure is further described by reference to the embodiments below. In the following detailed description, some exemplary embodiments of the present disclosure are described by way of illustration only. There is no doubt that, for a person of ordinary skill in the art, the described embodiments may be amended in a variety of different ways without departing from the spirit and scope of the present disclosure. Accordingly, the description is illustrative in nature and is not be construed as limiting the scope of protection of the claims.

### Embodiment 1

An oxygenating and rooting water-soluble fertilizer compounded with biostimulant was prepared by the following raw materials in parts by weight: 10 parts of urea powder, 20 parts of industrial grade monoammonium phosphate powder, 30 parts of potassium nitrate powder, 3 parts of oxygenating agent powder, 5 parts of type I stabilizer powder, 3 parts of type II stabilizer powder, 5 parts of biostimulant powder, 3 parts of medium trace element powder, and 0.8 parts of anti-hardening auxiliary agent powder.

Specifically,
the oxygenating agent powder was urea peroxide with a mass percentage of oxygen content of 14%-16%;
the type I stabilizer powder was anhydrous magnesium sulfate powder, and the type II stabilizer powder was potassium pyrophosphate powder, the potassium pyrophosphate powder having a pH value of 8-10 after being diluted by 1:250 times;
the biostimulant powder was formed by the following raw materials in parts by weight: 2.2 parts of seaweed active substance powder, 1 part of humic acid powder, 1 part of γ-aminobutyric acid powder, and 0.8 parts of vitamin powder,
the seaweed active substance powder being seaweed polysaccharide powder, with a mass percentage of alginic acid content of 20%-30%, a mass percentage of seaweed polysaccharide content of 15%-20%, and a mass percentage of organic matter content of 25%-30%, the seaweed active substance powder having a pH value of 5-7 after being diluted by 1:250 times,
the humic acid powder being mineral potassium fulvic acid powder, with a mass percentage of fulvic acid content of 45%-50%, a mass percentage of humic acid content of 50%-55%, and a mass percentage of potassium oxide content of 8%-12%, and
the vitamin powder being vitamin C, a mass percentage of vitamin C content being 90%-99%; and
the medium trace element powder was formed by 1.5 parts of EDTA-Fe, 0.75 parts of boric acid and 0.75 parts of EDTA-Zn.

The above raw materials were used for preparation according to the following steps.

In step 1, the oxygenating agent powder, the type I stabilizer powder and the type II stabilizer powder were fully and uniformly mixed according to a predetermined weight ratio, a mixture was left for standing for 1 h or more to be fully stabilized for later use, and an intermediate product A was obtained.

In step 2, stirring was performed while the urea powder, the industrial grade monoammonium phosphate powder and the potassium nitrate powder were sequentially added to a water-soluble fertilizer mixing machine according to a predetermined weight ratio, a rotational speed of the mixing machine being controlled at 200 rpm/min-260 rpm/min, and an intermediate product B was obtained.

In step 3, stirring was performed while the biostimulant powder was added to the intermediate product B obtained by the mixing machine according to a predetermined weight ratio, a rotational speed of the mixing machine being controlled at 200 rpm/min-260 rpm/min, and an intermediate product C was obtained.

In step 4, stirring was performed while the medium trace element powder and the anti-hardening auxiliary agent powder were sequentially added to the intermediate product C obtained by the mixing machine according to a predetermined weight ratio, a rotational speed of the mixing machine being controlled at 200 rpm/min-260 rpm/min, and an intermediate product D was obtained.

In step 5, the intermediate product A was added to the intermediate product D obtained by the mixing machine according to a predetermined weight ratio, and full and uniform mixing was continued to be performed for 8 min-9 min to obtain a final product, a water-soluble fertilizer Product I.

Moisture content of all raw materials was controlled at 3% or less, a temperature of a production workshop was controlled at lower than 27° C., and air humidity was controlled at 30%-50%.

### Embodiment 2

An oxygenating and rooting water-soluble fertilizer compounded with biostimulant was prepared by the following raw materials in parts by weight: 20 parts of urea powder, 30 parts of industrial grade monoammonium phosphate powder, 35 parts of potassium nitrate powder, 3 parts of oxygenating agent powder, 5 parts of type I stabilizer powder, 3 parts of type II stabilizer powder, 5 parts of biostimulant powder, 3 parts of medium trace element powder, and 0.8 parts of anti-hardening auxiliary agent powder.

Specifically,
the oxygenating agent powder was urea peroxide with a mass percentage of oxygen content of 14%-16%;
the type I stabilizer powder was anhydrous magnesium sulfate powder, and the type II stabilizer powder was potassium pyrophosphate powder, the potassium pyrophosphate powder having a pH value of 8-10 after being diluted by 1:250 times; and
the biostimulant powder was formed by the following raw materials in parts by weight: 2.2 parts of seaweed active substance powder, 1 part of humic acid powder, 1 part of γ-aminobutyric acid powder, and 0.8 parts of vitamin powder,
the seaweed active substance powder being seaweed polysaccharide powder, with a mass percentage of alginic acid content of 20%-30%, a mass percentage of seaweed polysaccharide content of 15%-20%, and a mass percentage of organic matter content of 25%-30%, the seaweed active substance powder having a pH value of 5-7 after being diluted by 1:250 times,
the humic acid powder being mineral potassium fulvic acid powder, with a mass percentage of fulvic acid content of 45%-50%, a mass percentage of humic acid content of 50%-55%, and a mass percentage of potassium oxide content of 8%-12%, and being 90%-99%; and
the medium trace element powder was formed by 1.5 parts of EDTA-Fe, 0.75 parts of boric acid and 0.75 parts of EDTA-Zn.

The above raw materials were used for preparation according to the following steps.

In step 1, the oxygenating agent powder, the type I stabilizer powder and the type II stabilizer powder were fully and uniformly mixed according to a predetermined weight ratio, a mixture was left for standing for 1 h or more to be fully stabilized for later use, and an intermediate product A was obtained.

In step 2, stirring was performed while the urea powder, the industrial grade monoammonium phosphate powder and the potassium nitrate powder were sequentially added to a water-soluble fertilizer mixing machine according to a predetermined weight ratio, a rotational speed of the mixing machine being controlled at 200 rpm/min-260 rpm/min, and an intermediate product B was obtained.

In step 3, stirring was performed while the biostimulant powder was added to the intermediate product B obtained by the mixing machine according to a predetermined weight ratio, a rotational speed of the mixing machine being controlled at 200 rpm/min-260 rpm/min, and an intermediate product C was obtained.

In step 4, stirring was performed while the medium trace element powder and the anti-hardening auxiliary agent powder were sequentially added to the intermediate product C obtained by the mixing machine according to a predetermined weight ratio, a rotational speed of the mixing machine being controlled at 200 rpm/min-260 rpm/min, and an intermediate product D was obtained.

In step 5, the intermediate product A was added to the intermediate product D obtained by the mixing machine according to a predetermined weight ratio, and full and uniform mixing was continued to be performed for 8 min-9 min to obtain a final product, a water-soluble fertilizer Product II.

Moisture content of all raw materials was controlled at 3% or less, a temperature of a production workshop was controlled at lower than 27° C., and air humidity was controlled at 30%-50%.

### Embodiment 3

An oxygenating and rooting water-soluble fertilizer compounded with biostimulant was prepared by the following raw materials in parts by weight: 20 parts of urea powder, 30 parts of industrial grade monoammonium phosphate powder, 35 parts of potassium nitrate powder, 1 part of oxygenating agent powder, 1 part of type I stabilizer powder, 1 part of type II stabilizer powder, 2.5 parts of biostimulant powder, 1.5 parts of medium trace element powder, and 0.5 parts of anti-hardening auxiliary agent powder.

### Specifically,

the oxygenating agent powder was urea peroxide with a mass percentage of oxygen content of 14%-16%;
the type I stabilizer powder was anhydrous magnesium sulfate powder, and the type II stabilizer powder was potassium pyrophosphate powder, the potassium pyrophosphate powder having a pH value of 8-10 after being diluted by 1:250 times;
the biostimulant powder was formed by the following raw materials in parts by weight: 1 part of seaweed active substance powder, 0.5 parts of humic acid powder, 0.5 parts of Y-aminobutyric acid powder, and 0.5 parts of vitamin powder,
the seaweed active substance powder being seaweed polysaccharide powder, with a mass percentage of alginic acid content of 20%-30%, a mass percentage of seaweed polysaccharide content of 15%-20%, and a mass percentage of organic matter content of 25%-30%, the seaweed active substance powder having a pH value of 5-7 after being diluted by 1:250 times,
the humic acid powder being mineral potassium fulvic acid powder, with a mass percentage of fulvic acid content of 45%-50%, a mass percentage of humic acid content of 50%-55%, and a mass percentage of potassium oxide content of 8%-12%, and
the vitamin powder being vitamin C, a mass percentage of vitamin C content being 90%-99%; and
the medium trace element powder was formed by 0. 5 parts of EDTA-Fe, 0. 5 parts of boric acid and 0.5 parts of EDTA-Zn.

The above raw materials were used for preparation according to the following steps.

In step 1, the oxygenating agent powder, the type I stabilizer powder and the type II stabilizer powder were fully and uniformly mixed according to a predetermined weight ratio, a mixture was left for standing for 1 h or more to be fully stabilized for later use, and an intermediate product A was obtained.

In step 2, stirring was performed while the urea powder, the industrial grade monoammonium phosphate powder and the potassium nitrate powder were sequentially added to a water-soluble fertilizer mixing machine according to a predetermined weight ratio, a rotational speed of the mixing machine being controlled at 200 rpm/min-260 rpm/min, and an intermediate product B was obtained.

In step 3, stirring was performed while the biostimulant powder was added to the intermediate product B obtained by the mixing machine according to a predetermined weight ratio, a rotational speed of the mixing machine being controlled at 200 rpm/min-260 rpm/min, and an intermediate product C was obtained.

In step 4, stirring was performed while the medium trace element powder and the anti-hardening auxiliary agent powder were sequentially added to the intermediate product C obtained by the mixing machine according to a predetermined weight ratio, a rotational speed of the mixing machine being controlled at 200 rpm/min-260 rpm/min, and an intermediate product D was obtained.

In step 5, the intermediate product A was added to the intermediate product D obtained by the mixing machine according to a predetermined weight ratio, and full and uniform mixing was continued to be performed for 8 min-9 min to obtain a final product, a water-soluble fertilizer Product III.

Moisture content of all raw materials was controlled at 3% or less, a temperature of a production workshop was controlled at lower than 27° C., and air humidity was controlled at 30%-50%.

### Embodiment 4

An oxygenating and rooting water-soluble fertilizer compounded with biostimulant was prepared by the following raw materials in parts by weight: 20 parts of urea powder, 30 parts of industrial grade monoammonium phosphate powder, 35 parts of potassium nitrate powder, 5 parts of oxygenating agent powder, 10 parts of type I stabilizer powder, 5 parts of type II stabilizer powder, 10 parts of biostimulant powder, 4 parts of medium trace element powder, and 1 part of anti-hardening auxiliary agent powder.

### Specifically,

the oxygenating agent powder was urea peroxide with a mass percentage of oxygen content of 14%-16%;
the type I stabilizer powder was anhydrous magnesium sulfate powder, and the type II stabilizer powder was potassium pyrophosphate powder, the potassium pyrophosphate powder having a pH value of 8-10 after being diluted by 1:250 times;
the biostimulant powder was formed by the following raw materials in parts by weight: 5 parts of seaweed active substance powder, 2 parts of humic acid powder, 2 parts of Y-aminobutyric acid powder, and 1 part of vitamin powder,
the seaweed active substance powder being seaweed polysaccharide powder, with a mass percentage of alginic acid content of 20%-30%, a mass percentage of seaweed polysaccharide content of 15%-20%, and a mass percentage of organic matter content of 25%-30%, the seaweed active substance powder having a pH value of 5-7 after being diluted by 1:250 times,
the humic acid powder being mineral potassium fulvic acid powder, with a mass percentage of fulvic acid content of 45%-50%, a mass percentage of humic acid content of 50%-55%, and a mass percentage of potassium oxide content of 8%-12%, and being 90%-99%; and
the medium trace element powder was formed by 2 parts of EDTA-Fe, 1 part of boric acid and 1 part of EDTA-Zn.

The above raw materials were used for preparation according to the following steps.

In step 1, the oxygenating agent powder, the type I stabilizer powder and the type II stabilizer powder were fully and uniformly mixed according to a predetermined weight ratio, a mixture was left for standing for 1 h or more to be fully stabilized for later use, and an intermediate product A was obtained.

In step 2, stirring was performed while the urea powder, the industrial grade monoammonium phosphate powder and the potassium nitrate powder were sequentially added to a water-soluble fertilizer mixing machine according to a predetermined weight ratio, a rotational speed of the mixing machine being controlled at 200 rpm/min-260 rpm/min, and an intermediate product B was obtained.

In step 3, stirring was performed while the biostimulant powder was added to the intermediate product B obtained by the mixing machine according to a predetermined weight ratio, a rotational speed of the mixing machine being controlled at 200 rpm/min-260 rpm/min, and an intermediate product C was obtained.

In step 4, stirring was performed while the medium trace element powder and the anti-hardening auxiliary agent powder were sequentially added to the intermediate product C obtained by the mixing machine according to a predetermined weight ratio, a rotational speed of the mixing machine being controlled at 200 rpm/min-260 rpm/min, and an intermediate product D was obtained.

In step 5, the intermediate product A was added to the intermediate product D obtained by the mixing machine according to a predetermined weight ratio, and full and uniform mixing was continued to be performed for 8 min-9 min to obtain a final product, a water-soluble fertilizer Product IV.

Moisture content of all raw materials was controlled at 3% or less, a temperature of a production workshop was controlled at lower than 27° C., and air humidity was controlled at 30%-50%.

### Embodiment 5

An oxygenating and rooting water-soluble fertilizer compounded with biostimulant was prepared by the following raw materials in parts by weight: 30 parts of urea powder, 35 parts of industrial grade monoammonium phosphate powder, 40 parts of potassium nitrate powder, 3 parts of oxygenating agent powder, 5 parts of type I stabilizer powder, 3 parts of type II stabilizer powder, 5 parts of biostimulant powder, 3 parts of medium trace element powder, and 0.8 part of anti-hardening auxiliary agent powder.

### Specifically,

the oxygenating agent powder was urea peroxide with a mass percentage of oxygen content of 14%-16%;
the type I stabilizer powder was anhydrous magnesium sulfate powder, and the type II stabilizer powder was potassium pyrophosphate powder, the potassium pyrophosphate powder having a pH value of 8-10 after being diluted by 1:250 times;
the biostimulant powder was formed by the following raw materials in parts by weight: 2. 2 parts of seaweed active substance powder, 1 part of humic acid powder, 1 part of Y-aminobutyric acid powder, and 0.8 parts of vitamin powder,
the seaweed active substance powder being seaweed polysaccharide powder, with a mass percentage of alginic acid content of 20%-30%, a mass percentage of seaweed polysaccharide content of 15%-20%, and a mass percentage of organic matter content of 25%-30%, the seaweed active substance powder having a pH value of 5-7 after being diluted by 1:250 times,
the humic acid powder being mineral potassium fulvic acid powder, with a mass percentage of fulvic acid content of 45%-50%, a mass percentage of humic acid content of 50%-55%, and a mass percentage of potassium oxide content of 8%-12%, and being 90%-99%; and
the medium trace element powder was formed by 1.5 parts of EDTA-Fe, 0.75 parts of boric acid and 0.75 parts of EDTA-Zn.

The above raw materials were used for preparation according to the following steps.

In step 1, the oxygenating agent powder, the type I stabilizer powder and the type II stabilizer powder were fully and uniformly mixed according to a predetermined weight ratio, a mixture was left for standing for 1 h or more to be fully stabilized for later use, and an intermediate product A was obtained.

In step 2, stirring was performed while the urea powder, the industrial grade monoammonium phosphate powder and the potassium nitrate powder were sequentially added to a water-soluble fertilizer mixing machine according to a predetermined weight ratio, a rotational speed of the mixing machine being controlled at 200 rpm/min-260 rpm/min, and an intermediate product B was obtained.

In step 3, stirring was performed while the biostimulant powder was added to the intermediate product B obtained by the mixing machine according to a predetermined weight ratio, a rotational speed of the mixing machine being controlled at 200 rpm/min-260 rpm/min, and an intermediate product C was obtained.

In step 4, stirring was performed while the medium trace element powder and the anti-hardening auxiliary agent powder were sequentially added to the intermediate product C obtained by the mixing machine according to a predetermined weight ratio, a rotational speed of the mixing machine being controlled at 200 rpm/min-260 rpm/min, and an intermediate product D was obtained.

In step 5, the intermediate product A was added to the intermediate product D obtained by the mixing machine according to a predetermined weight ratio, and full and uniform mixing was continued to be performed for 8 min-9 min to obtain a final product, a water-soluble fertilizer Product V.

Moisture content of all raw materials was controlled at 3% or less, a temperature of a production workshop was controlled at lower than 27° C., and air humidity was controlled at 30%-50%.

### Comparative Embodiment 1

The water-soluble fertilizer in the prior art included 20 parts of urea powder, 30 parts of industrial grade monoammonium phosphate powder, and 35 parts of potassium nitrate powder, which were uniformly mixed to obtain a Comparative Product I.

### Comparative Embodiment 2

An oxygenating and rooting water-soluble fertilizer compounded with biostimulant was prepared by the following raw materials in parts by weight: 20 parts of urea powder, 30 parts of industrial grade monoammonium phosphate powder, 35 parts of potassium nitrate powder, 3 parts of oxygenating agent powder, 5 parts of type I stabilizer powder, 3 parts of type II stabilizer powder, 3 parts of medium trace element powder, and 0.8 parts of anti-hardening auxiliary agent powder.

### Specifically,

the oxygenating agent powder was urea peroxide with a mass percentage of oxygen content of 14%-16%;
the type I stabilizer powder was anhydrous magnesium sulfate powder, and the type II stabilizer powder was potassium pyrophosphate powder, the potassium pyrophosphate powder having a pH value of 8-10 after being diluted by 1:250 times; and
the medium trace element powder was formed by 1.5 parts of EDTA-Fe, 0.75 parts of boric acid and 0.75 parts of EDTA-Zn.

The above raw materials were used for preparation according to the following steps.

In step 1, the oxygenating agent powder, the type I stabilizer powder and the type II stabilizer powder were fully and uniformly mixed according to a predetermined weight ratio, a mixture was left for standing for 1 h or more to be fully stabilized for later use, and an intermediate product A was obtained.

In step 2, stirring was performed while the urea powder, the industrial grade monoammonium phosphate powder and the potassium nitrate powder were sequentially added to a water-soluble fertilizer mixing machine according to a predetermined weight ratio, a rotational speed of the mixing machine being controlled at 200 rpm/min-260 rpm/min, and an intermediate product B was obtained.

In step 3, stirring was performed while the medium trace element powder and the anti-hardening auxiliary agent powder were sequentially added to the intermediate product B obtained by the mixing machine according to a predetermined weight ratio, a rotational speed of the mixing machine being controlled at 200 rpm/min-260 rpm/min, and an intermediate product D was obtained.

In step 4, the intermediate product A was added to the intermediate product D obtained by the mixing machine according to a predetermined weight ratio, and full and uniform mixing was continued to be performed for 8 min-9 min to obtain a final product, a water-soluble fertilizer Comparative Product II.

Moisture content of all raw materials was controlled at 3% or less, a temperature of a production workshop was controlled at lower than 27° C., and air humidity was controlled at 30%-50%.

### Comparative Embodiment 3

An oxygenating and rooting water-soluble fertilizer compounded with biostimulant was prepared by the following raw materials in parts by weight: 20 parts of urea powder, 30 parts of industrial grade monoammonium phosphate powder, 35 parts of potassium nitrate powder, 5 parts of biostimulant powder, 3 parts of medium trace element powder, and 0.8 parts of anti-hardening auxiliary agent powder.

### Specifically,

the biostimulant powder was formed by the following raw materials in parts by weight: 2.2 parts of seaweed active substance powder, 1 part of humic acid powder, 1 part of γ-aminobutyric acid powder, and 0.8 parts of vitamin powder,
the seaweed active substance powder being seaweed polysaccharide powder, with a mass percentage of alginic acid content of 20%-30%, a mass percentage of seaweed polysaccharide content of 15%-20%, and a mass percentage of organic matter content of 25%-30%, the seaweed active substance powder having a pH value of 5-7 after being diluted by 1:250 times,
the humic acid powder being mineral potassium fulvic acid powder, with a mass percentage of fulvic acid content of 45%-50%, a mass percentage of humic acid content of 50%-55%, and a mass percentage of potassium oxide content of 8%-12%, and
the vitamin powder was vitamin C, a mass percentage of vitamin C content being 90%-99%; and
the medium trace element powder was formed by 1.5 parts of EDTA-Fe, 0.75 parts of boric acid and 0.75 parts of EDTA-Zn.

| | | Industrial | | | | | | | Anti- |
|---|---|---|---|---|---|---|---|---|---|
| | | grade | | | | | | Medium | hardening |
| | | monoammonium | Potassium | Oxygenating | Type I | Type II | | trace | auxiliary |
| | Urea | phosphate | nitrate | agent | stabilizer | stabilizer | Biostimulant | element | agent |
| | (in | (in | (in | (in | (in | (in | (in | (in | (in |
| Product | parts by | parts by | parts by | parts by | parts by | parts by | parts by | parts by | parts by |
| name | weight) | weight) | weight) | weight) | weight) | weight) | weight) | weight) | weight) |
| Product I | 10 | 20 | 30 | 3 | 5 | 3 | 5 | 3 | 0.8 |
| Product II | 20 | 30 | 35 | 3 | 5 | 3 | 5 | 3 | 0.8 |
| Product III | 20 | 30 | 35 | 1 | 1 | 1 | 2.5 | 1.5 | 0.5 |
| Product IV | 20 | 30 | 35 | 5 | 10 | 5 | 10 | 4 | 1 |
| Product V | 30 | 35 | 40 | 3 | 5 | 3 | 5 | 3 | 0.8 |
| Comparative | 20 | 30 | 35 | 0 | 0 | 0 | 0 | 0 | 0 |
| Product I | | | | | | | | | |
| Comparative | 20 | 30 | 35 | 3 | 5 | 3 | 0 | 3 | 0.8 |
| Product II | | | | | | | | | |
| Comparative | 20 | 30 | 35 | 0 | 0 | 0 | 5 | 3 | 0.8 |
| Product III | | | | | | | | | |

The above raw materials were used for preparation according to the following steps.

In step 1, stirring was performed while the urea powder, the industrial grade monoammonium phosphate powder and the potassium nitrate powder were added to a water-soluble fertilizer mixing machine according to a predetermined weight ratio, a rotational speed of the mixing machine being controlled at 200 rpm/min-260 rpm/min, and an intermediate product B was obtained.

In step 2, stirring was performed while the biostimulant powder was added to the intermediate product B obtained by the mixing machine according to a predetermined weight ratio, a rotational speed of the mixing machine being controlled at 200 rpm/min-260 rpm/min, and an intermediate product C was obtained.

In step 3, stirring was performed while the medium trace element powder and the anti-hardening auxiliary agent powder were sequentially added to the intermediate product C obtained by the mixing machine according to a predetermined weight ratio, a rotational speed of the mixing machine being controlled at 200 rpm/min-260 rpm/min, and an intermediate product D was obtained.

In step 4, the intermediate product A was added to the intermediate product D obtained by the mixing machine according to a predetermined weight ratio, and full and uniform mixing was continued to be performed for 8 min-9 min to obtain a final product, a water-soluble fertilizer Comparative Product III.

Moisture content of all raw materials was controlled at 3% or less, a temperature of a production workshop was controlled at lower than 27° C., and air humidity was controlled at 30%-50%.

The compositional ratios of the above five embodiments and three comparative embodiments are tabulated below.

Table 1 Compositional ratios of test raw materials

A total of two kinds of crops are tested in the present disclosure:
(I) For the test on Capsicum annuum, the above Products I to V and Comparative Products I to III are used, with a total of eight groups of tests.
(II) For the test on Zingiber officinale Roscoe, two groups of tests are conducted using Product II and Comparative Product I.
(I) Test on Capsicum annuum
   Test procedure and results:
The fertilizers prepared from the above five embodiments and three comparative embodiments are subjected to agronomic tests as follows:
Tested crop: Capsicum annuum (Capsicum chinensis);
Test site: Greenhouse of National Slow and Controlled Release Fertilizer Engineering and Technology Research Center in Linyi (pot test); and
Facility greenhouse in Chenlou Village, Qingzhou City, Weifang City, Shandong Province (field test);
Hardened and poor permeable clay is used for the test;
   Table of specific composition of soil:

TABLE 2
Soil property for pot test

| Alkali- | | Rapidly | | | | | Volume |
|---|---|---|---|---|---|---|---|
| hydrolyzable | Available | available | | Organic | Exchangeable | Exchangeable | weight |
| nitrogen | phosphorous | potassium | | matter | Ca | Mg | of soil |
| (mg/kg) | (mg/kg) | (mg/kg) | pH | (%) | (mg/kg) | (mg/kg) | (g/cm³) |
| 111.87 | 48.62 | 137.821 | 5.14 | 1.08 | 3.31 | 5.18 | 1.5 |

TABLE 3
Soil property for field test

| Alkali- | | Rapidly | | | | | Volume |
|---|---|---|---|---|---|---|---|
| hydrolyzable | Available | available | | Organic | Exchangeable | Exchangeable | weight |
| nitrogen | phosphorous | potassium | | matter | Ca | Mg | of soil |
| (mg/kg) | (mg/kg) | (mg/kg) | pH | (%) | (mg/kg) | (mg/kg) | (g/cm³) |
| 285.55 | 115.41 | 165.39 | 7.63 | 1.71 | 3.45 | 4.67 | 1.7 |

Tested fertilizer: Product I, Product II, Product III, Product IV, Product V, Comparative Product I, Comparative Product II, and Comparative Product III.

Test design: the agronomic test is carried out in the form of field test combined with pot test.

(1) Pot test

3 plastic flower pots of same size were selected for each tested fertilizer test, a total of 24 pots for eight products, and each pot was filled with 5 kg of sieved potting soil. Capsicum annuum seedlings with consistent growth were selected for transplanting at seedling stage. Water-soluble fertilizer (diluted by 500 times with water) was applied to each pot in 1 g/time in a flushing manner, once in 7-10 days, a total of 4 times. The operation and management except for the type of water-soluble fertilizer were consistent for each tested fertilizer test.

TABLE 4
Pot test design

| | | Amount of | |
|---|---|---|---|
| Product | Number of | fertilizer | Fertilization |
| name | test pots | applied | times |
| Product I | 3 | 1 g/pot/time | 4 |
| Product II | 3 | 1 g/pot/time | 4 |
| Product III | 3 | 1 g/pot/time | 4 |
| Product IV | 3 | 1 g/pot/time | 4 |
| Product V | 3 | 1 g/pot/time | 4 |
| Comparative | 3 | 1 g/pot/time | 4 |
| Product I | | | |
| Comparative | 3 | 1 g/pot/time | 4 |
| Product II | | | |
| Comparative | 3 | 1 g/pot/time | 4 |
| Product III | | | |

Determination items and methods: plant height, stem diameter, chlorophyll, root system biomass, stem and leaf biomass, and total biomass of Capsicum annuum were determined at the harvest stage in the pot test.

Analysis of test results:

TABLE 5
Determination of oxygenating indexes and root system indexes in pot test

| | | | | Fresh | | | | |
|---|---|---|---|---|---|---|---|---|
| | | | Fresh | weight | | Root | | |
| | Dissolved | Dissolved | weight | increase | Root | system | | Rhizome |
| | oxygen | oxygen | of root | of root | system | length | Rhizome | diameter |
| Product | content | increase | system | system | length | increase | diameter | increase |
| name | (ml/L) | (%) | (g) | (%) | (cm) | (%) | (mm) | (%) |
| Product I | 5.69 | 6.4 | 17.60 | 5.4 | 16.50 | 0.6 | 1.46 | 8.1 |
| Product II | 5.68 | 6.1 | 18.50 | 10.8 | 17.26 | 5.2 | 1.51 | 11.8 |
| Product III | 5.42 | 1.3 | 17.62 | 3.7 | 16.58 | 1.1 | 1.48 | 9.6 |
| Product IV | 5.80 | 8.4 | 17.66 | 5.5 | 17.15 | 4.6 | 1.42 | 5.2 |
| Product V | 5.66 | 5.8 | 18.55 | 11.1 | 17.21 | 4.9 | 1.53 | 13.3 |
| Comparative | 5.35 | — | 16.7 | — | 16.4 | — | 1.35 | — |
| Product I | | | | | | | | |
| Comparative | 5.67 | 6 | 16.95 | 1.5 | 16.36 | −0.2 | 1.37 | 1.5 |
| Product II | | | | | | | | |
| Comparative | 5.33 | −0.4 | 17.11 | 2.5 | 16.68 | 1.7 | 1.32 | −2.2 |
| Product III | | | | | | | | |

The test data in Table 5 is analyzed as follows. By applying the water-soluble fertilizer Products I to V prepared by the present application, with the fertilizer base system ratios of Product II, Product III and product IV being consistent except for different ratios of oxygenating agents and biostimulants, it can be seen that when the fertilizer base system ratios are consistent, more content of oxygenating agent and biostimulant is not always better, and when the ratio of Product II is adopted, the synergistic effect of various raw materials is best exerted, and therefore Product II is the optimal embodiment. Product I and Product V have different fertilizer base system ratios. Product I has a small fertilizer base system ratio, so it is significantly poor in all aspects of performance, while Product V has a high fertilizer base system ratio, so it is significantly better in all aspects of performance. In terms of the indexes of fresh weight of root system and rhizome diameter of Capsicum annuum, Product V is better than Product II, but in terms of root system length, Product V is slightly worse than Product II, and the cost on raw materials of Product V is increased. Overall, Product II is the optimal embodiment. Products I to V significantly improve the dissolved oxygen content in irrigation water, and significantly improve root system weight, root system length and rhizome diameter, showing obvious effect of oxygenating and rooting. The experimental data of Comparative Product I, which is the existing common fertilizer, shows inferior dissolved oxygen content, root system weight, root system length and rhizome diameter to those achieved by Product II. In addition, Comparative Product II, which is the common fertilizer with only oxygenating agent added, is acceptable in terms of dissolved oxygen content and fresh weight of root system, but is significantly inferior to Product II in terms of root system length and rhizome diameter. Comparative Product III, which is the common fertilizer with only biostimulant added, is significantly inferior to the other groups in terms of dissolved oxygen content, acceptable in fresh weight of root system and root system length, and significantly inferior to Product II in terms of rhizome diameter. It can be seen from the above that, for Product II, the addition of oxygenating agent and biostimulant to the common fertilizer achieves a synergistic and optimized technical effect, and by means of the mutual promotion and cooperation of the two, the dissolved oxygen content of soil and the growth of Capsicum annuum are improved.

| | | | | | | | | Above- |
|---|---|---|---|---|---|---|---|---|
| | | | | | | | Above- | ground |
| | | Plant | | Stem | | | ground | fresh |
| | Plant | height | Stem | diameter | | Chlorophyll | fresh | weight |
| Product | height | increase | diameter | increase | | increase | weight | increase |
| name | (cm) | (%) | (mm) | (%) | Chlorophyll | (%) | (g) | (%) |
| Product I | 38.5 | 0.5 | 6.75 | 2.3 | 52.1 | 2.0 | 132.59 | 6.2 |
| Product II | 39.4 | 2.9 | 6.95 | 5.3 | 53.7 | 5.1 | 144.16 | 15.5 |
| Product III | 38.5 | 0.5 | 6.88 | 3.8 | 51.5 | 0.8 | 133.78 | 7.2 |
| Product IV | 39.0 | 1.8 | 6.79 | 2.9 | 53.9 | 5.5 | 139.55 | 11.8 |
| Product V | 39.5 | 3.1 | 6.98 | 5.8 | 53.0 | 3.7 | 145.90 | 16.9 |
| Comparative | 38.3 | — | 6.6 | — | 51.1 | — | 124.8 | — |
| Product I | | | | | | | | |
| Comparative | 38 | −0.8 | 6.63 | 0.5 | 51.8 | 1.4 | 128.21 | 2.7 |
| Product II | | | | | | | | |
| Comparative | 39.1 | 2.1 | 6.75 | 2.3 | 51.7 | 1.2 | 130.36 | 4.5 |
| Product III | | | | | | | | |

### Table 6 Determination of Growth Indexes of Capsicum Annuum in Pot Test

The data in Table 6 is analyzed as follows. By applying the water-soluble fertilizer Products I to V prepared by the present application, three growth indexes of plant height, stem diameter and chlorophyll content of Capsicum annuum are significantly improved, especially for Product II, the above-ground fresh weight of Capsicum annuum is significantly increased, a 15. 5% increase over Comparative Product I, indicating that the water-soluble fertilizer prepared by the present application enables Capsicum annuum more robust, and has obvious growth promotion effect. The experimental data of Comparative Product I, which is the existing common fertilizer, shows that neither plant height nor above-ground fresh weight is superior to that achieved by Product II. In addition, Comparative Product II, which is the common fertilizer with only oxygenating agent added, is significantly inferior to Product II in terms of the indexes of plant height and chlorophyll content. Comparative Product III, which is the common fertilizer with only biostimulant added, is acceptable in plan height and stem diameter, significantly inferior to the other groups in terms of chlorophyll content, and inferior to the performance of Product II. Product I and Product V have different fertilizer base system ratios. Product I has a small fertilizer base system ratio, so it is significantly poor in all aspects of performance, while Product V has a high fertilizer base system ratio, so it is significantly better in all aspects of performance. In terms of the indexes of plant height, stem diameter, and above-ground fresh weight, Product V is better than Product II, but in terms of the index of chlorophyll, Product V is slightly worse than Product II, and the cost on raw materials of Product V is increased. Overall, Product II is the optimal embodiment. For Products I to V, the addition of oxygenating agent and biostimulant to the common fertilizer achieves a synergistic and optimized technical effect, and by means of the mutual promotion and cooperation of the two, three growth indexes of plan height, stem diameter and chlorophyll content of Capsicum annuum are improved, showing obvious growth promotion effect. Product II is the optimal embodiment.

(2) Field test

The field test was carried out in facility greenhouses of Qingzhou City of Shandong Province, and 0.5 mu was selected for each tested fertilizer test, a total greenhouse area of 3 mu, with Capsicum annuum cultivation density of 2000 plants/mu. Drip irrigation was selected as the irrigation mode, and clay was selected for the test. Due to consecutive years of planting, the soil hardening and soil-borne disease problems were prominent. The operation and management except for the type of water-soluble fertilizer were consistent for each tested fertilizer test.

TABLE 7
Field test design

| | | Amount of | |
|---|---|---|---|
| Product | Test | fertilizer | Fertilization |
| name | area | applied | times |
| Product I | 0.5 mu | 5 kg/mu/time | 4 |
| Product II | 0.5 mu | 5 kg/mu/time | 4 |
| Product III | 0.5 mu | 5 kg/mu/time | 4 |
| Product IV | 0.5 mu | 5 kg/mu/time | 4 |
| Product V | 0.5 mu | 5 kg/mu/time | 4 |
| Comparative | 0.5 mu | 5 kg/mu/time | 4 |
| Product I | | | |
| Comparative | 0.5 mu | 5 kg/mu/time | 4 |
| Product II | | | |
| Comparative | 0.5 mu | 5 kg/mu/time | 4 |
| Product III | | | |

Plant height, stem diameter, chlorophyll, root system biomass, stem and leaf biomass, and total biomass of Capsicum annuum were determined in the harvest stage of the field test, and the yield and the number of dead plants of Capsicum annuum were counted. Prior to the test treatments, 100 consecutive Capsicum annuum of uniform growth were selected separately for each group of tests for late yield counting, with five times of yield counting for each group of tests. The plant height was determined from the soil surface to the top of Capsicum annuum using a tape measure, the stem diameter and the chlorophyll content were determined using a vernier caliper and a soil and plant analyzer development (SPAD) meter, respectively, and the biomass and the yield of Capsicum annuum were determined using a balance.

### Analysis of Test Results:

TABLE 8
Determination of oxygenating indexes and root system indexes in field test

| | | | | Fresh | | | | |
|---|---|---|---|---|---|---|---|---|
| | | | Fresh | weight | | Root | | |
| | Dissolved | Dissolved | weight | increase | Root | system | | Rhizome |
| | oxygen | oxygen | of root | of root | system | length | Rhizome | diameter |
| Product | content | increase | system | system | length | increase | diameter | increase |
| name | (ml/L) | (%) | (g) | (%) | (cm) | (%) | (mm) | (%) |
| Product I | 5.35 | 8.0 | 19.85 | 2.6 | 18.33 | 1.9 | 1.70 | 1.2 |
| Product II | 5.33 | 7.6 | 23.66 | 22.3 | 19.10 | 4.9 | 1.81 | 7.7 |
| Product III | 5.06 | 2.2 | 21.38 | 10.5 | 18.25 | 0.2 | 1.74 | 3.6 |
| Product IV | 5.53 | 11.7 | 22.01 | 13.7 | 19.05 | 4.6 | 1.81 | 7.7 |
| Product V | 5.35 | 8.0 | 23.72 | 22.6 | 19.05 | 4.6 | 1.83 | 8.9 |
| Comparative | 4.95 | — | 19.35 | — | 18.21 | — | 1.68 | — |
| Product I | | | | | | | | |
| Comparative | 5.36 | 8.3 | 20.43 | 5.6 | 18.08 | −0.7 | 1.71 | 1.8 |
| Product II | | | | | | | | |
| Comparative | 4.97 | 0.4 | 20.56 | 6.3 | 18.52 | 1.7 | 1.74 | 3.6 |
| Product III | | | | | | | | |

The test data in Table 8 is analyzed as follows. By applying the water-soluble fertilizer Products I to V prepared by the present application, the dissolved oxygen content in irrigation water is increased significantly, the root system weight, the root system length and the rhizome diameter are dramatically improved, showing obvious effect of oxygenating and rooting. The experimental data of Comparative Product I, which is the existing common fertilizer, shows inferior dissolved oxygen content, root system weight, root system length and rhizome diameter to those achieved by Product II. In addition, Comparative Product II, which is the common fertilizer with only oxygenating agent added, is acceptable in terms of dissolved oxygen content and fresh weight of root system, but is significantly inferior to Product II in terms of root system length and rhizome diameter. Comparative Product III, which is the common fertilizer with only biostimulant added, is significantly inferior to the other groups in terms of dissolved oxygen content, acceptable in terms of fresh weight of root system and root system length, and significantly inferior to Product II in terms of rhizome diameter. Of Products I to V, which are added with oxygenating agents and biostimulants on the basis of common fertilizers, Product II, Product III and Product V have consistent fertilizer base system ratios except for the different ratios of oxygenating agents and biostimulants, and it can be seen that when the fertilizer base system ratios are consistent, more content of oxygenating agent and biostimulant are not always better, and when the ratio of Product II is adopted, the synergistic effect of various raw materials is best exerted, so Product II is the optimal embodiment. Product I and Product V have different fertilizer base system ratios. Product I has a small fertilizer base system ratio, so it is significantly poor in all aspects of performance, while Product V has a high fertilizer base system ratio, so it is significantly better in all aspects of performance. In terms of the indexes of fresh weight of root system and rhizome diameter, Product Vis better than Product II, but in terms of the index of root system length, Product V is slightly worse than Product II, and the cost on raw materials of Product V is increased. Overall, Product II is the optimal embodiment. It can be seen from the above that, for Products I to V, the addition of oxygenating agent and biostimulant to the common fertilizer achieves a synergistic and optimized technical effect, and by means of the mutual promotion and cooperation of the two, the dissolved oxygen content of soil is improved and the growth of Capsicum annuum is promoted. By comprehensive comparison, Product II is the optimal embodiment.

TABLE 9
Determination of growth indexes of Capsicum annuum in field test

| | | | | | | | | Single | | |
|---|---|---|---|---|---|---|---|---|---|---|
| | | Plant | | Stem | | | Single | fruit | | |
| | Plant | height | Stem | diameter | | Chlorophyll | fruit | weight | | Yield |
| Product | height | increase | diameter | increase | | increase | weight | increase | Yield | increase |
| name | (cm) | (%) | (mm) | (%) | Chlorophyll | (%) | (g) | (%) | (kg) | (%) |
| Product I | 182.0 | 0.3 | 8.90 | 2.8 | 63.6 | 3.2 | 92.1 | 1.7 | 298.5 | 5.1 |
| Product II | 184.0 | 1.4 | 9.13 | 5.4 | 65.8 | 6.8 | 94.3 | 4.1 | 328.5 | 15.7 |
| Product III | 183.1 | 0.9 | 9.05 | 4.5 | 64.0 | 3.9 | 92.5 | 2.1 | 305.6 | 7.6 |
| Product IV | 183.5 | 1.1 | 8.95 | 3.3 | 62.9 | 2.1 | 93.0 | 2.6 | 320.7 | 12.9 |
| Product V | 184.3 | 1.5 | 9.10 | 5.1 | 65.2 | 5.8 | 94.5 | 4.3 | 333.0 | 16.2 |
| Comparative | 181.5 | — | 8.66 | — | 61.6 | — | 90.6 | — | 284 | — |
| Product I | | | | | | | | | | |
| Comparative | 182.1 | 0.3 | 8.83 | 2 | 63.1 | 2.4 | 91.3 | 0.8 | 293.5 | 3.3 |
| Product II | | | | | | | | | | |
| Comparative | 180.9 | −0.3 | 8.75 | 1 | 62.3 | 1.1 | 91.9 | 1.4 | 297.6 | 4.8 |
| Product III | | | | | | | | | | |

The data in Table 9 is analyzed as follows. By applying the water-soluble fertilizer Products I to V prepared by the present application, the plant height, the stem diameter, and the chlorophyll content are significantly improved, which are more in line with the results obtained from the pot test. Product II of the optimal embodiment has an increase of about 4.5 cm in the average plant height, and an increase of 0.47 mm and 1.5 mm in the stem diameter and the chlorophyll content, respectively, over Comparative Product I. Significant yield increasing effect can be achieved by applying the water-soluble fertilizers prepared in the present application. After 5 times of yield counting of consecutive 100 plants of Capsicum annuum, the yield of Capsicum annuum treated by oxygenating water-soluble fertilizer is 328.5 kg, a 15.7% increase compared with that of 284.0 kg by applying Comparative Product I, and in addition, single fruit weight of Capsicum annuum is increased by 3.7 g compared with Comparative Product I, with a significant difference, indicating that by treating Capsicum annuum with the water-soluble fertilizer prepared by the present application, the fruit swelling effect is better. The experimental data of Product I, which is the existing common fertilizer, shows that neither plant height nor above-ground fresh weight is superior to that achieved by Product II. In addition, Comparative Product II, which is the common fertilizer with only oxygenating agent added, is significantly inferior to Product II in terms of the indexes of plant height and chlorophyll content. Comparative Product III, which is the common fertilizer with only biostimulant added, is acceptable in terms of plant height and stem diameter, significantly inferior to other groups in terms of chlorophyll content, and inferior to the performance of Product II. It can be seen from the above that, for Product II, the addition of oxygenating agent and biostimulant to the common fertilizer achieves a synergistic and optimized technical effect, and the two contribute to the improvement of the three growth indexes of plant height, stem diameter and chlorophyll content of Capsicum annuum, showing obvious growth promotion effect. Product I and Product V have different fertilizer base system ratios. Product I has a small fertilizer base system ratio, so it is significantly poor in all aspects of performance, while Product V has a high fertilizer base system ratio, so it is significantly better in all aspects of performance. In terms of plant height, single fruit weight and yield of Capsicum annuum, Product Vis better than Product II, but in terms of the indexes of chlorophyll and stem diameter, Product V is slightly worse than Product II, and the cost on raw materials of Product V is increased. Overall, Product II is the optimal embodiment.

### Test on Zingiber Officinale Roscoe

For the test on Zingiber officinale Roscoe, Product II in the optimal embodiment and Comparative Product I are selected.

### Test Procedure and Results:

Tested crop: Zingiber officinale Roscoe;
Test site: Xiaolijia Village, Dongxia Town, Qingzhou City, Shandong Province. Qingzhou City is located in the middle of Shandong Province, with geographic coordinates of east longitude of 118° 10′ −118° 46′ and north latitude of 36° 24′ −36° 56′. Dongxia Town is located in the eastern part of Qingzhou City, with a vast planting area of Zingiber officinale Roscoe, and Zingiber officinale Roscoe is planted in consecutive years, which leads to the deterioration of soil environment and the prominent problem of continuous cropping obstacles. The test plot has been planted with Zingiber officinale Roscoe for 8 consecutive years, and is a typical continuous cropping plot.

### Table of Specific Composition of Soil:

TABLE 10
Soil property of test soil

| Alkali- | | Rapidly | | | | | Volume |
|---|---|---|---|---|---|---|---|
| hydrolyzable | Available | available | | Organic | Exchangeable | Exchangeable | weight |
| nitrogen | phosphorous | potassium | | matter | Ca | Mg | of soil |
| (mg/kg) | (mg/kg) | (mg/kg) | pH | (%) | (mg/kg) | (mg/kg) | (g/cm³) |
| 136.71 | 98.44 | 145.86 | 6.88 | 2.14 | 210.43 | 68.90 | 1.60 |

Tested fertilizer: Product II, and Comparative Product I.

Test design: the test was carried out in the form of a field test. The test was divided into two groups: a control check (CK) group and a test (T) group. In CK group, the common type of Comparative Product I was applied in the middle and late stages of the growth of Zingiber officinale Roscoe in a flushing manner, a total of 4 times, and similarly, in T group, Product II was applied to Zingiber officinale Roscoe in a flushing manner, a total of 4 times, with 5 kg/mu for each time in both groups. The operation and management except for the application of water-soluble fertilizer were consistent in CK and T groups.

| | | | Amount of | |
|---|---|---|---|---|
| | Fertilizer | Test | fertilizer | Fertilization |
| Number | variety | area | applied | times |
| CK | Comparative | 1 mu | 5 kg/mu/time | 4 |
| | Product I | | | |
| T | Product II | 1 mu | 5 kg/mu/time | 4 |

### Table 11 Test Design

Determination items and methods: the chlorophyll content and plant height were determined in three-branch stage, seven-stemmed stage, maximum branching stage and harvest stage of Zingiber officinale Roscoe, respectively, with the chlorophyll content being determined by an SPAD instrument, and the plant height being determined by a tape measure. In the harvest stage of Zingiber officinale Roscoe, 10 m length of Zingiber officinale Roscoe was randomly taken in each of the two treatments to determine the yield, with three replicates in each treatment; the stem diameter of Zingiber officinale Roscoe was determined by a vernier caliper, and the number of branches of Zingiber officinale Roscoe was counted; and Zingiber officinale Roscoe was weighted with a balance after stems were cut and the mud was removed, and the weight was converted into the yield of Zingiber officinale Roscoe according to the length of ridge of one mu of Zingiber officinale Roscoe. In the harvest stage of Zingiber officinale Roscoe, the number of dead plants of Zingiber officinale Roscoe was investigated by counting and was converted into the dead rate according to the number of Zingiber officinale Roscoe planted.

Determination of oxygenating and root system indexes:

TABLE 12
Determination of oxygenating indexes and root system indexes

| | Dissolved oxygen | Fresh weight of | Root system | Rhizome |
|---|---|---|---|---|
| | content | root system | length | diameter |
| | (mL/L) | (g) | (cm) | (mm) |
| CK | 6.05 | 12.85 a | 15.30 a | 1.10 a |
| T | 6.57 | 13.10 b | 15.86 b | 1.31 b |

The data in Table 12 is analyzed as follows. By applying the water-soluble fertilizer Product II prepared by the present application, the dissolved oxygen content in irrigation water is improved, the root system weight, the root system length and the rhizome diameter of Zingiber officinale Roscoe are significantly improved, showing obvious effect of oxygenating and rooting.

### Determination of Growth Indexes of Zingiber Officinale Roscoe:

TABLE 13
Determination of chlorophyll content of Zingiber officinale Roscoe
at different stages

| | | | Maximum | |
|---|---|---|---|---|
| | Three-branch | Seven-stem | branching | Harvest |
| Stage | stage | stage | stage | stage |
| CK | 43.56 | 56.78 | 58.55 | 36.77 |
| T | 42.91 | 58.32 | 63.15 | 41.91 |

TABLE 14
Determination of plant height of Zingiber officinale Roscoe
at different stages (cm)

| | | | Maximum | |
|---|---|---|---|---|
| | Three-branch | Seven-stem | branching | Harvest |
| Stage | stage | stage | stage | stage |
| CK | 31.4 | 44.8 | 67.32 | 88.82 |
| T | 31.2 | 47.7 | 70.73 | 93.44 |

TABLE 15
Determination of various growth indexes in the
harvest stage of Zingiber officinale Roscoe

| | Stem | | | | | |
|---|---|---|---|---|---|---|
| | diameter | Increase | Number of | Increase | Yield | Increase |
| | (mm) | (%) | branches | (%) | (kg/mu) | (%) |
| CK | 13.78 a | — | 14.53 a | — | 4025.3 | — |
| T | 14.25 ab | 3.4 | 15.37 b | 5.8 | 4438.6 | 10.3 |

The data in Table 13 to Table 15 is analyzed as follows. By applying the water-soluble fertilizer Product II prepared by the present application, the chlorophyll content of leaves and plant height of Zingiber officinale Roscoe at different stages are improved. For Product II, the chlorophyll of Zingiber officinale Roscoe at the harvest stage is improved by 5.14 spad, and the plant heights at the maximum branching stage and the harvest stage are improved by 3.41 cm and 4.62 cm, respectively, compared with Comparative Product I, with significant differences, indicating that Zingiber officinale Roscoe is promoted significantly by applying the water-soluble fertilizer Product II prepared by the present application. In addition, by applying the water-soluble fertilizer Product II prepared in the present application, the stem diameter, the average number of branches and the yield of Zingiber officinale Roscoe are significantly increased. The yield of Zingiber officinale Roscoe in T group is about 4438.6 kg/mu, increased by 413.3 kg/mu compared to that of about 4025.3 kg/mu in CK group, a 10.3% increase, and the overall effect of yield increase is obvious.

It can be seen that the water-soluble fertilizer provided by the present application achieves unexpected technical effects on the growth of both Capsicum annuum and Zingiber officinale Roscoe. When the fertilizer base system ratios are consistent, there is an optimal ratio value for the ratios of oxygenating agent and biostimulant, i.e., the ratio of Product II, indicating that more content of oxygenating agent and biostimulant is not always better. The synergistic effect of various raw materials is best exerted when the ratio of Product II is adopted, and therefore Product II is the optimal embodiment. When the fertilizer base system ratios are different and the ratios of oxygenating agent and biostimulant are invariant, the differences in various aspects of crop performance are obvious, so it can be seen that the higher the value of the fertilizer base system ratio, the better the effect achieves, but the cost on raw materials will be increased accordingly. Considering the cost-effectiveness overall, Product II is the optimal embodiment.

In addition:

The commonly used oxygenating agents include sodium percarbonate, calcium peroxide, hydrogen peroxide and urea peroxide. In the present application, urea peroxide is not arbitrarily selected as an oxygenating agent, but is ultimately selected after many tests. In the test process, it is found that sodium percarbonate is prone to inflating in water-soluble fertilizer, and is harmful to the normal growth of crops due to it contains sodium ions; calcium peroxide is prone to decomposition affected by the temperature, light and other factors, and is not stable enough added in the water-soluble fertilizer; and hydrogen peroxide in the form of liquid is not suitable to be added in solid water-soluble fertilizer. Therefore, in the present application, urea peroxide is ultimately selected as an oxygenating agent, which is generated by the combination reaction between hydrogen peroxide and urea, with a mass percentage of oxygen content of 14%-16%, and its preparation process belongs to the prior art.

The type I stabilizer is anhydrous magnesium sulfate, which mainly serves to eliminate the hardening, effectively alleviating the phenomenon of hardening between the oxygenating agent and other components.

The type II stabilizer is potassium pyrophosphate, which mainly serves to provide an alkaline environment for the oxygenating agent, avoiding decomposition of the oxygenating agent under acidic conditions or the occurrence of inflation and instability.

The type I stabilizer and the type II stabilizer are indispensable, which mainly serve to ensure the stability of product quality, and avoid the decomposition, inflation and hardening of oxygenating agent.

### The Function of Four Biostimulants in the Present Disclosure

(1) Seaweed polysaccharide powder: seaweed polysaccharide can adsorb nutrient elements from the soil, prevent nutrient loss, and can also promote the absorption and utilization of these nutrients by plants.
(2) Mineral potassium fulvic acid: it can improve soil granular structure, loosen the soil, improve the soil's ability to retain water and fertilizers, regulate pH value, reduce the content of heavy metals in the soil, and reduce the harm of salt ions to seeds and seedlings.
(3) γ-aminobutyric acid: it is involved in various physiological processes of plant growth and development, such as root system structure, stem elongation, leaf senescence, pollen tube growth, fruit ripening and seed germination, and effectively promotes the robust growth of crops and their root systems by participating in the physiological processes of crops.
(4) Vitamin C: it has an antioxidant effect, which helps plants resist harmful free radicals, reduces the damage caused by environmental stresses, and promotes the growth of crop root systems in adverse environments.

The four biostimulant are synergistic mutually and indispensable, effectively promote the robust growth of crop root systems in an all-round way from the four dimensions of nutrition, soil, physiology, and environment, and promote the effect of oxygenating agent to enhance the effect of fertilizer.

The necessity of the sequence of adding powder in the preparation of the present disclosure.
(1) In step 1, the oxygenating agent is first mixed with the type I stabilizer and the type II stabilizer, which can make the property of the oxygenating agent more stable, without hardening and inflation, and increase the stability of the product, and the powder after mixing is for later use.
(2) In step 2, the three basic raw materials of the urea powder, the industrial grade monoammonium phosphate powder, and the potassium nitrate powder are added to the mixing machine and mixed, to form a stable fertilizer base system, which is conducive to the subsequent addition and mixing of various components.
(3) In step 3, the four biostimulants are added to the powder prepared in step 2, which ensures better and full mixing of biostimulant and nutrients.
(4) In step 4, the medium trace elements and the anti-hardening auxiliary agent are added to the powder after mixing in step 3, the amount of the two substances used is the smallest and the powder is finer, and optimal effect can be achieved by adding the two substances at this time.
(5) Finally, the powder obtained in step 1 is added, at which time the powder obtained in step 1 has better stability and the product property is more stable.

The water-soluble fertilizer obtained according to the above addition steps has the best property and is most suitable for industrialization and long-term storage.

The medium trace element of the present disclosure may be selected from at least one of iron, zinc, boron and manganese, not limited to the use of the raw materials of EDTA-Fe, boric acid, EDTA-Zn, and may also be other forms of medium trace elements.

The dissolved oxygen content in the present disclosure is determined by iodometric method, a conventional method of chemical analysis, in which the oxygen content is determined by the reaction of iodine with dissolved oxygen. Of course, electrochemical method and paramagnetic method can also be used.

The above shows and describes the basic principles, main features and advantages of the present disclosure. It is to be understood by those skilled in the art that the present disclosure is not limited to the above embodiments, what is described in the above embodiments and specification is only the principle of the present disclosure, and various variations and improvements without departing from the spirit and scope of the present disclosure can be made, which fall within the scope of the present disclosure that claims protection. The scope of protection claimed by the present invention is defined by the attached claims and equivalents thereof.

1. An oxygenating and rooting water-soluble fertilizer compounded with biostimulant, prepared by the following raw materials in parts by weight: 10-30 parts of urea powder, 20-35 parts of industrial grade monoammonium phosphate powder, 30-40 parts of potassium nitrate powder, 1-5 parts of oxygenating agent powder, 1-10 parts of type I stabilizer powder, 1-5 parts of type II stabilizer powder, 2.5-10 parts of biostimulant powder, 1.5-4 parts of medium trace element powder, and 0.5-1 part of anti-hardening auxiliary agent powder.

2. The oxygenating and rooting water-soluble fertilizer compounded with biostimulant according to claim 1, wherein the oxygenating agent powder is urea peroxide with a mass percentage of oxygen content of 14%-16%.

3. The oxygenating and rooting water-soluble fertilizer compounded with biostimulant according to claim 1, wherein the type I stabilizer powder is anhydrous magnesium sulfate powder, and the type II stabilizer powder is potassium pyrophosphate powder, the potassium pyrophosphate powder having a pH value of 8-10 after being diluted by 1:250 times.

4. The oxygenating and rooting water-soluble fertilizer compounded with biostimulant according to claim 1, wherein the biostimulant powder is formed by the following raw materials in parts by weight: 1-5 parts of seaweed active substance powder, 0.5-2 parts of humic acid powder, 0.5-2 parts of γ-aminobutyric acid powder, and 0.5-1 part of vitamin powder.

5. The oxygenating and rooting water-soluble fertilizer compounded with biostimulant according to claim 4, wherein the seaweed active substance powder is seaweed polysaccharide powder, with a mass percentage of alginic acid content of 20%-30%, a mass percentage of seaweed polysaccharide content of 15%-20%, and a mass percentage of organic matter content of 25%-30%, the seaweed active substance powder having a pH value of 5-7 after being diluted by 1:250 times.

6. The oxygenating and rooting water-soluble fertilizer compounded with biostimulant according to claim 4, wherein the humic acid powder is mineral potassium fulvic acid powder, with a mass percentage of fulvic acid content of 45%-50%, a mass percentage of humic acid content of 50%-55%, and a mass percentage of potassium oxide content of 8%-12%.

7. The oxygenating and rooting water-soluble fertilizer compounded with biostimulant according to claim 4, wherein the vitamin powder is vitamin C, a mass percentage of vitamin C content being 90%-99%.

8. The oxygenating and rooting water-soluble fertilizer compounded with biostimulant according to claim 1, wherein the medium trace element powder is at least one of ethylene diamine tetraacetic acid (EDTA)-Fe powder, boric acid powder and EDTA-Zn powder.

9. A preparation method for an oxygenating and rooting water-soluble fertilizer compounded with biostimulant according to claim 1, comprising the following steps:
step 1, fully and uniformly mixing oxygenating agent powder, type I stabilizer powder and type II stabilizer powder according to a predetermined weight ratio, leaving a mixture for 1 h or more to fully stabilize for later use, and obtaining an intermediate product A;
step 2, performing stirring while sequentially adding urea powder, industrial grade monoammonium phosphate powder and potassium nitrate powder to a water-soluble fertilizer mixing machine according to a predetermined weight ratio, a rotational speed of the mixing machine being controlled at 200 rpm/min-260 rpm/min, and obtaining an intermediate product B;
step 3, performing stirring while adding biostimulant powder to the intermediate product B obtained by the mixing machine according to a predetermined weight ratio, a rotational speed of the mixing machine being controlled at 200 rpm/min-260 rpm/min, and obtaining an intermediate product C;
step 4, performing stirring while sequentially adding medium trace element powder and anti-hardening auxiliary agent powder to the intermediate product C obtained by the mixing machine according to a predetermined weight ratio, a rotational speed of the mixing machine being controlled at 200 rpm/min-260 rpm/min, and obtaining an intermediate product D; and
step 5, adding the intermediate product A to the intermediate product D obtained by the mixing machine according to a predetermined weight ratio, and continuing to fully and uniformly mixing for 8 min-9 min to obtain a final product, a water-soluble fertilizer.

10. A preparation method for an oxygenating and rooting water-soluble fertilizer compounded with biostimulant according to claim 2, comprising the following steps:
step 1, fully and uniformly mixing oxygenating agent powder, type I stabilizer powder and type II stabilizer powder according to a predetermined weight ratio, leaving a mixture for 1 h or more to fully stabilize for later use, and obtaining an intermediate product A;
step 2, performing stirring while sequentially adding urea powder, industrial grade monoammonium phosphate powder and potassium nitrate powder to a water-soluble fertilizer mixing machine according to a predetermined weight ratio, a rotational speed of the mixing machine being controlled at 200 rpm/min-260 rpm/min, and obtaining an intermediate product B;
step 3, performing stirring while adding biostimulant powder to the intermediate product B obtained by the mixing machine according to a predetermined weight ratio, a rotational speed of the mixing machine being controlled at 200 rpm/min-260 rpm/min, and obtaining an intermediate product C;
step 4, performing stirring while sequentially adding medium trace element powder and anti-hardening auxiliary agent powder to the intermediate product C obtained by the mixing machine according to a predetermined weight ratio, a rotational speed of the mixing machine being controlled at 200 rpm/min-260 rpm/min, and obtaining an intermediate product D; and
step 5, adding the intermediate product A to the intermediate product D obtained by the mixing machine according to a predetermined weight ratio, and continuing to fully and uniformly mixing for 8 min-9 min to obtain a final product, a water-soluble fertilizer.

11. A preparation method for an oxygenating and rooting water-soluble fertilizer compounded with biostimulant according to claim 3, comprising the following steps:
step 1, fully and uniformly mixing oxygenating agent powder, type I stabilizer powder and type II stabilizer powder according to a predetermined weight ratio, leaving a mixture for 1 h or more to fully stabilize for later use, and obtaining an intermediate product A;
step 2, performing stirring while sequentially adding urea powder, industrial grade monoammonium phosphate powder and potassium nitrate powder to a water-soluble fertilizer mixing machine according to a predetermined weight ratio, a rotational speed of the mixing machine being controlled at 200 rpm/min-260 rpm/min, and obtaining an intermediate product B;
step 3, performing stirring while adding biostimulant powder to the intermediate product B obtained by the mixing machine according to a predetermined weight ratio, a rotational speed of the mixing machine being controlled at 200 rpm/min-260 rpm/min, and obtaining an intermediate product C;
step 4, performing stirring while sequentially adding medium trace element powder and anti-hardening auxiliary agent powder to the intermediate product C obtained by the mixing machine according to a predetermined weight ratio, a rotational speed of the mixing machine being controlled at 200 rpm/min-260 rpm/min, and obtaining an intermediate product D; and
step 5, adding the intermediate product A to the intermediate product D obtained by the mixing machine according to a predetermined weight ratio, and continuing to fully and uniformly mixing for 8 min-9 min to obtain a final product, a water-soluble fertilizer.

12. A preparation method for an oxygenating and rooting water-soluble fertilizer compounded with biostimulant according to claim 4, comprising the following steps:
step 1, fully and uniformly mixing oxygenating agent powder, type I stabilizer powder and type II stabilizer powder according to a predetermined weight ratio, leaving a mixture for 1 h or more to fully stabilize for later use, and obtaining an intermediate product A;
step 2, performing stirring while sequentially adding urea powder, industrial grade monoammonium phosphate powder and potassium nitrate powder to a water-soluble fertilizer mixing machine according to a predetermined weight ratio, a rotational speed of the mixing machine being controlled at 200 rpm/min-260 rpm/min, and obtaining an intermediate product B;
step 3, performing stirring while adding biostimulant powder to the intermediate product B obtained by the mixing machine according to a predetermined weight ratio, a rotational speed of the mixing machine being controlled at 200 rpm/min-260 rpm/min, and obtaining an intermediate product C;
step 4, performing stirring while sequentially adding medium trace element powder and anti-hardening auxiliary agent powder to the intermediate product C obtained by the mixing machine according to a predetermined weight ratio, a rotational speed of the mixing machine being controlled at 200 rpm/min-260 rpm/min, and obtaining an intermediate product D; and
step 5, adding the intermediate product A to the intermediate product D obtained by the mixing machine according to a predetermined weight ratio, and continuing to fully and uniformly mixing for 8 min-9 min to obtain a final product, a water-soluble fertilizer.

13. A preparation method for an oxygenating and rooting water-soluble fertilizer compounded with biostimulant according to claim 5, comprising the following steps:
step 1, fully and uniformly mixing oxygenating agent powder, type I stabilizer powder and type II stabilizer powder according to a predetermined weight ratio, leaving a mixture for 1 h or more to fully stabilize for later use, and obtaining an intermediate product A;
step 2, performing stirring while sequentially adding urea powder, industrial grade monoammonium phosphate powder and potassium nitrate powder to a water-soluble fertilizer mixing machine according to a predetermined weight ratio, a rotational speed of the mixing machine being controlled at 200 rpm/min-260 rpm/min, and obtaining an intermediate product B;
step 3, performing stirring while adding biostimulant powder to the intermediate product B obtained by the mixing machine according to a predetermined weight ratio, a rotational speed of the mixing machine being controlled at 200 rpm/min-260 rpm/min, and obtaining an intermediate product C;
step 4, performing stirring while sequentially adding medium trace element powder and anti-hardening auxiliary agent powder to the intermediate product C obtained by the mixing machine according to a predetermined weight ratio, a rotational speed of the mixing machine being controlled at 200 rpm/min-260 rpm/min, and obtaining an intermediate product D; and
step 5, adding the intermediate product A to the intermediate product D obtained by the mixing machine according to a predetermined weight ratio, and continuing to fully and uniformly mixing for 8 min-9 min to obtain a final product, a water-soluble fertilizer.

14. A preparation method for an oxygenating and rooting water-soluble fertilizer compounded with biostimulant according to claim 6, comprising the following steps:
step 1, fully and uniformly mixing oxygenating agent powder, type I stabilizer powder and type II stabilizer powder according to a predetermined weight ratio, leaving a mixture for 1 h or more to fully stabilize for later use, and obtaining an intermediate product A;
step 2, performing stirring while sequentially adding urea powder, industrial grade monoammonium phosphate powder and potassium nitrate powder to a water-soluble fertilizer mixing machine according to a predetermined weight ratio, a rotational speed of the mixing machine being controlled at 200 rpm/min-260 rpm/min, and obtaining an intermediate product B;
step 3, performing stirring while adding biostimulant powder to the intermediate product B obtained by the mixing machine according to a predetermined weight ratio, a rotational speed of the mixing machine being controlled at 200 rpm/min-260 rpm/min, and obtaining an intermediate product C;
step 4, performing stirring while sequentially adding medium trace element powder and anti-hardening auxiliary agent powder to the intermediate product C obtained by the mixing machine according to a predetermined weight ratio, a rotational speed of the mixing machine being controlled at 200 rpm/min-260 rpm/min, and obtaining an intermediate product D; and
step 5, adding the intermediate product A to the intermediate product D obtained by the mixing machine according to a predetermined weight ratio, and continuing to fully and uniformly mixing for 8 min-9 min to obtain a final product, a water-soluble fertilizer.

15. A preparation method for an oxygenating and rooting water-soluble fertilizer compounded with biostimulant according to claim 7, comprising the following steps:
step 1, fully and uniformly mixing oxygenating agent powder, type I stabilizer powder and type II stabilizer powder according to a predetermined weight ratio, leaving a mixture for 1 h or more to fully stabilize for later use, and obtaining an intermediate product A;
step 2, performing stirring while sequentially adding urea powder, industrial grade monoammonium phosphate powder and potassium nitrate powder to a water-soluble fertilizer mixing machine according to a predetermined weight ratio, a rotational speed of the mixing machine being controlled at 200 rpm/min-260 rpm/min, and obtaining an intermediate product B;
step 3, performing stirring while adding biostimulant powder to the intermediate product B obtained by the mixing machine according to a predetermined weight ratio, a rotational speed of the mixing machine being controlled at 200 rpm/min-260 rpm/min, and obtaining an intermediate product C;
step 4, performing stirring while sequentially adding medium trace element powder and anti-hardening auxiliary agent powder to the intermediate product C obtained by the mixing machine according to a predetermined weight ratio, a rotational speed of the mixing machine being controlled at 200 rpm/min-260 rpm/min, and obtaining an intermediate product D; and
step 5, adding the intermediate product A to the intermediate product D obtained by the mixing machine according to a predetermined weight ratio, and continuing to fully and uniformly mixing for 8 min-9 min to obtain a final product, a water-soluble fertilizer.

16. A preparation method for an oxygenating and rooting water-soluble fertilizer compounded with biostimulant according to claim 8, comprising the following steps:
step 1, fully and uniformly mixing oxygenating agent powder, type I stabilizer powder and type II stabilizer powder according to a predetermined weight ratio, leaving a mixture for 1 h or more to fully stabilize for later use, and obtaining an intermediate product A;
step 2, performing stirring while sequentially adding urea powder, industrial grade monoammonium phosphate powder and potassium nitrate powder to a water-soluble fertilizer mixing machine according to a predetermined weight ratio, a rotational speed of the mixing machine being controlled at 200 rpm/min-260 rpm/min, and obtaining an intermediate product B;
step 3, performing stirring while adding biostimulant powder to the intermediate product B obtained by the mixing machine according to a predetermined weight ratio, a rotational speed of the mixing machine being controlled at 200 rpm/min-260 rpm/min, and obtaining an intermediate product C;
step 4, performing stirring while sequentially adding medium trace element powder and anti-hardening auxiliary agent powder to the intermediate product C obtained by the mixing machine according to a predetermined weight ratio, a rotational speed of the mixing machine being controlled at 200 rpm/min-260 rpm/min, and obtaining an intermediate product D; and
step 5, adding the intermediate product A to the intermediate product D obtained by the mixing machine according to a predetermined weight ratio, and continuing to fully and uniformly mixing for 8 min-9 min to obtain a final product, a water-soluble fertilizer.

17. The preparation method for an oxygenating and rooting water-soluble fertilizer compounded with biostimulant according to claim 9, wherein moisture content of all raw materials is controlled at 3% or less, a temperature of a production workshop is controlled at lower than 27° C., and air humidity is controlled at 30%-50%.

18. The preparation method for an oxygenating and rooting water-soluble fertilizer compounded with biostimulant according to claim 9, wherein moisture content of all raw materials is controlled at 3% or less, a temperature of a production workshop is controlled at lower than 27° C., and air humidity is controlled at 30%-50%.

19. The preparation method for an oxygenating and rooting water-soluble fertilizer compounded with biostimulant according to claim 10, wherein moisture content of all raw materials is controlled at 3% or less, a temperature of a production workshop is controlled at lower than 27° C., and air humidity is controlled at 30%-50%.

20. The preparation method for an oxygenating and rooting water-soluble fertilizer compounded with biostimulant according to claim 11, wherein moisture content of all raw materials is controlled at 3% or less, a temperature of a production workshop is controlled at lower than 27° C., and air humidity is controlled at 30%-50%.
